(19) United States
(12) Patent Application Publication
(10) Pub. No.: US 2013/0024781 A1
(43) Pub. Date: Jan. 24, 2013

(54) Multi-Modal and Updating Interface for Messaging

(71) Applicants: Ludovic Douillet, Escondido, CA (US); Nobukazu Sugiyama, San Diego, CA (US); William Collins, San Diego, CA (US); Jeffrey Tang, San Diego, CA (US)

(72) Inventors: Ludovic Douillet, Escondido, CA (US); Nobukazu Sugiyama, San Diego, CA (US); William Collins, San Diego, CA (US); Jeffrey Tang, San Diego, CA (US)

(73) Assignee: SONY CORPORATION, Tokyo (JP)

(21) Appl. No.: 13/189,115

(22) Filed: Jul. 22, 2011

(51) Int. Cl. G06F 3/048; G06F 15/16

(52) U.S. Cl. 715/752

(57) ABSTRACT

An electronic device designed for electronic messaging is configured to provide multiple options for including content into an electrical communication. For example, the device can provide content including one or combinations of letters, numbers, audio, video, graphics such as pictures, icons, or emoticons. The user of such an electronic communication device can select certain input options on a user interface to select from among various types of content to include in an electronic communication. The content from which the user may choose can be updated and changed on a periodic basis through communication between the user's electronic communication device and a central computing device. The central computing device can be controlled by a manufacturer of the computing device, a communication service provider, the user, or other third party to periodically change the messaging content options for a user.

### TECHNICAL FIELD

This invention relates generally to messaging devices, and more particularly to interfaces that provide input options for messaging devices.

### BACKGROUND

There has been an explosion in the number of devices and methods used to communicate among people and among electronic devices. People can communicate using personal communication devices such as mobile phones or smart phones and using computing devices such as tablets, laptops, or desktop computers. Such electronic devices may communicate with other electronic devices wirelessly or via wired connections.

In conjunction with the rise of new ways to communicate using new communication devices, the methods of communicating have also expanded. For example, the use of social networks has changed the way people communicate in much the same way that new electronic devices have allowed people to physically communicate in new ways. For instance, instead of communicating only by voice, written communication, or more recently by long-form email, people now also communicate using text or through short messages exchanged via social networks. The content of this communication has changed as well. For example, communication is no longer exclusively in long-form written prose; instead people use icons such as emoticons or unconventional acronyms to speed communication. The desire to include other content beyond full words, letters, or numbers within a particular communication places an increased strain on the ability of the communication device to seamlessly provide these options to a user.

### BRIEF DESCRIPTION OF THE DRAWINGS

FIG. 1 comprises a flow diagram for an example operation of a user communication device as configured in accordance with various embodiments of the invention;

FIG. 2 comprises an example display for a user configuration device as configured in accordance with various embodiments of the invention;

FIG. 3 comprises an example display for a user configuration device as configured in accordance with various embodiments of the invention;

FIG. 4 comprises an example display for a user configuration device as configured in accordance with various embodiments of the invention;

FIG. 5 comprises an example display for a user configuration device as configured in accordance with various embodiments of the invention;

FIG. 6 comprises a block diagram of an example system as configured in accordance with various embodiments of the invention; and

FIG. 7 comprises a flow diagram for an example operation of a central computing device as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking and pursuant to these various embodiments, an electronic device designed for electronic communication is configured to provide multiple options for including content into an electrical communication. For example, the communication device can provide content including one or combinations of letters, numbers, audio, video, graphics such as pictures, icons, or emoticons. The user of such an electronic communication device can select certain input options on a user interface to select from among various types of content to include in an electronic communication. One input option, for example, may include selecting to include one of a plurality of icons in an electronic communication. The plurality of icons from which the user may choose can be updated and changed on a periodic basis through communication between the user's electronic communication device and a central computing device. The central computing device can be controlled by a manufacturer of the computing device, a communication service provider, the user, or other third party.

So configured, the electronic communication device can provide varying content for inclusion in electronic communications. For example, by updating the content available for use through communication with the central computing device, the user can access icons or other content that is seasonal or relating to other subject matter that may change over time. Such subject matter can include information relating to pop culture, sporting events, seasonal themes, and the like. The content may also include content related to other third parties that may contract with the controller of the central computing device to provide additional subject matter or icons to be included as content in electronic communications. This variety of subject matter that is available as content in electrical communications thereby enhances the user experience with respect to the electronic communication device.

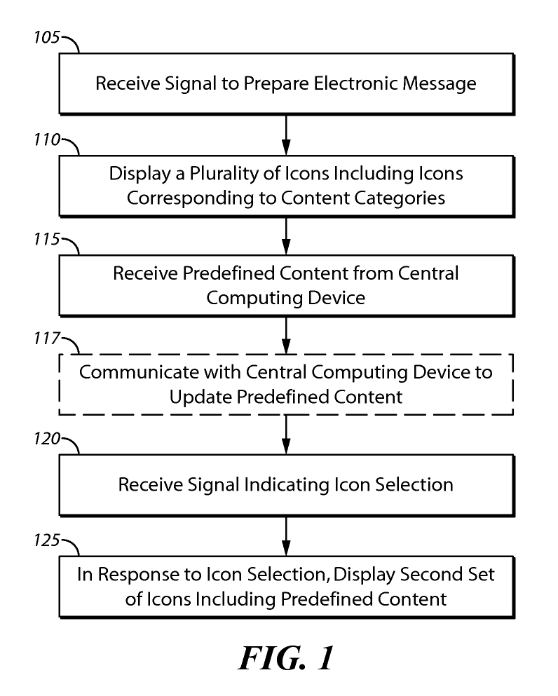

Referring now to the drawings and in particular to FIG. 1, an illustrative process compatible with many of these teachings will now be presented. This method includes receiving 105 a signal to prepare an electronic message to be sent from the communication device. By one approach, the signal is received from a user input device in communication with the communication device. For example, the user input device may be a touch interface on a display screen for a portable electronic communication device such as a cell phone, a tablet computing device, or other devices capable of enabling user initiated communications. Other human interface devices such as keyboards, mice, or the like can be used as well.

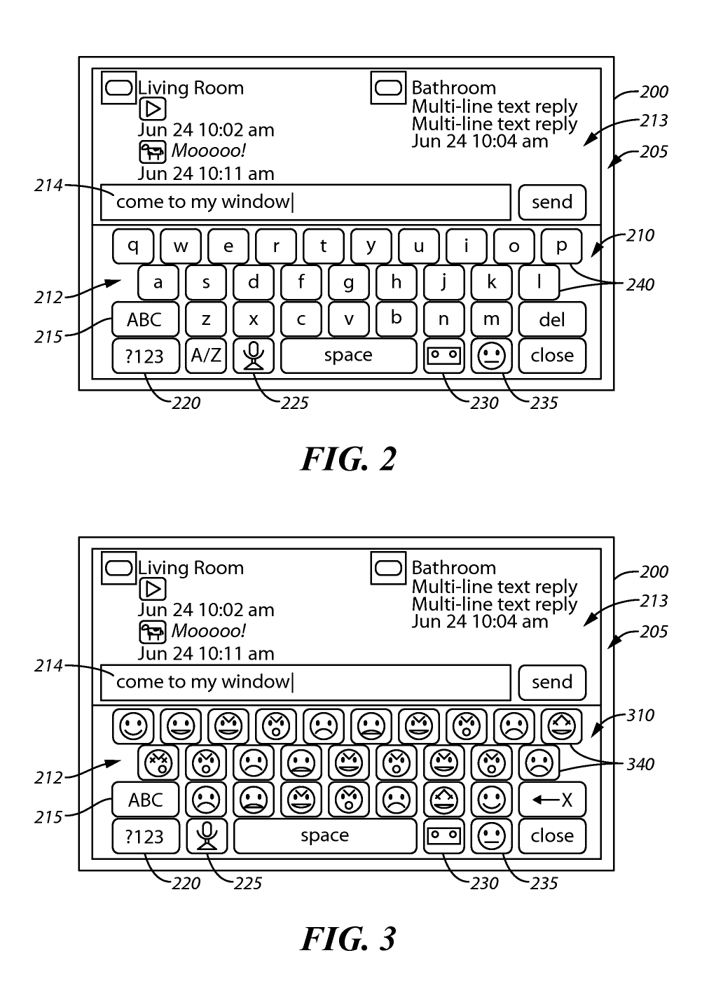

The method further includes displaying 110 a plurality of icons on a display device for the communication device, wherein a sub-set of the plurality of icons includes icons corresponding to different categories of content to include in the electronic message. In addition, the displaying the plurality of icons may include displaying individual ones of the icons that correspond to content to be inserted into the electronic message. With momentary reference to FIG. 2, an example communication device 200 includes a display portion 205 that is configured to display in an input portion 210 various input types available and to display in a messaging portion 213 messaging information received from other communication devices and a new message draft area 214. In this example, the input portion 210 of the display portion 205 comprises a touch screen portion such that touching any one of the displayed icons causes an input signal to be received by the electronic communication device 200, in response to which the communication device 200 notes the input and responds accordingly. In this example, the input portion 210 includes a QWERTY-type keyboard 212 and various specialized icons that when selected will effect a change of the input options. These specialized icons include a caps lock icon 215, a numbers icon 220, a voice input icon 225, a “canned” response icon 230, and an emoticon icon 235. These icons 215, 220, 225, 230, and 235 correspond to different categories of content to include in the electronic message being composed by the user of the communication device 200 such that selection of one will trigger the communication device 200 to display icons or selection elements corresponding to content for the selected category. In contrast, selection of one of the individual icons 240 associated with individual letters will trigger insertion of that letter into a draft communication or message in response to selection of the individual icon. This correspondence between an individual icon and a particular piece of content is true for other content available for selection and inclusion into an electronic message as described below.

Referring again to FIG. 1, the method includes receiving 115 from a central computing device predefined content available to be inserted into the electronic message. By one approach, the communication device periodically communicates 117 with the central computing device to update the predefined content available to be inserted into the electronic message. Details regarding the predefined content will be described below.

The method of FIG. 1 further includes the electronic communication device receiving 120 a user signal indicating selection of a selected icon of the subset of the plurality of icons and in response displaying 125 a second set of icons at least partially different from the first set of icons. Referring again to FIG. 2, in one example, a user can select the emoticon icon 235, and in response the electronic communication device 200 provides a new user interface such as the example shown in FIG. 3. This new user interface 310 includes a plurality of icons 340 representing different emoticon figures that can be included in an electronic communication. In other words, the icons representing emoticons to be included in an electronic communication are different from the letter icons 240 available for selection in the user input portion 210 of FIG. 2.

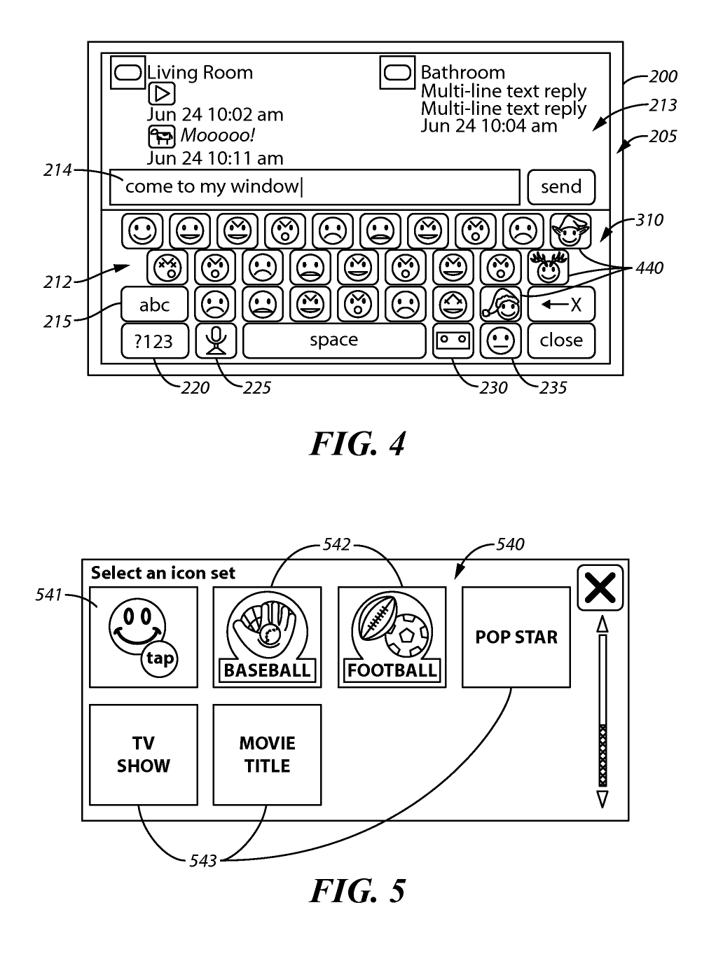

So configured, individual ones of the second set of icons represent content corresponding to a category of content, for example emoticons, corresponding to the selected icon of the subset of the plurality of icons and available to be inserted into the electronic message in response to selection of the individual icon. This display of the second set of icons is configured such that at least some of the second set of icons represent the predefined content from the central computing device. For example, if the predefined content from the central computing device included emoticons having a holiday theme, then the user interface when selecting the emoticon category of content may instead look like that of the example of FIG. 4, where certain of the emoticons 440 include holiday theme designs.

In another example, selecting the emoticon button 235 of the user input portion 210 shown in the example of FIG. 2 may provide to the user a selection of different categories of emoticons for which content available for inclusion in an electronic message is available. For instance, after selection of the emoticon button 235, the user interface in this example provides an array 540 of icons such as that of FIG. 5 where each of the array 540 of icons corresponds to a different category of content. Example categories include emoticons 541, sports based content 542, pop culture based content 543, and the like. So configured, the predefined content can be defined at least in part in response to consideration paid by a third party. In such an approach, third parties may provide consideration to a provider of the communication service such that in response to selection of an emoticon button 235 for selection of such a category of content, the user is provided the option of seeing content related to a particular artist, sports team, or other subject sponsored by the third party. The reverse may also be true where a user of an electronic communication device can pay consideration to have the right to use particular content associated with a sports team or pop culture personality in an electronic message.

By one approach, the second set of icons displayed after a category selection automatically updates with a different set of icons to reflect the update of the predefined content available to be inserted into the electronic message. In this approach, the electronic communication device will automatically periodically communicate with the central computing device to update the categories of content and particular pieces of content that are available to be inserted into an electronic communication. In this approach, the content is updated seamlessly for the convenience of the user.

In another optional approach, the method may include defining in response to user input how to periodically communicate with the central computing device to update the predefined content. For instance, the user may define one or more of a timing of the periodic communication with the central computing device, which categories to update, the method of periodically communicating with the central computing device, or the types of content received from the central computing device. For example, the timing may be set such that the communication with the central computing device occurs once every week, every month, or more frequently such as every day to obtain the most up to date content. The user may also define which categories of content to update. For example, the user may choose to only receive updates relating to emoticons and not relating to other categories of content. By another approach, the user may choose only particular commercial content to update on a periodic basis. For instance, the user may choose to receive updates to content regarding various sports teams and to ignore updates with respect to pop culture. The user may define the method of periodically communicating with the central computing device by specifying that the updating be accomplished only over a particular wireless connection or a particular network connection with the central computing device. For instance, a user may define that the updating occur automatically in response to detecting a network connection with the central computing device, or the user may restrict the methods of communicating with the central computing device such as only when a wired connection is detected or the like. The types of content to receive from the central computing device may include emoticon type content, audio content, video content, or short “canned” text content. For example, a particular short audio clip such as a spoken catch-phrase or particular sound may comprise a piece of content that can be included in an electrical communication. Similarly, a short video clip can be available for inclusion in an electronic communication that can then be easily inserted through selection of an icon corresponding to that video clip. The same may apply to short messages or acronyms that are commonly typed into electronic messages; therefore such portions of content can be more easily inserted into an electronic communication through selection of a single icon instead of typing in the short message or acronym. In this way, for example, a communication service provider may provide for a user several commonly used phrases or acronyms that can be available to be inserted in an electronic communication through a single icon selection. By another approach, the user can define particular audio, video, or text-based message portions that can then be associated with a particular icon and included on the user interface for single press inclusion into an electronic communication.

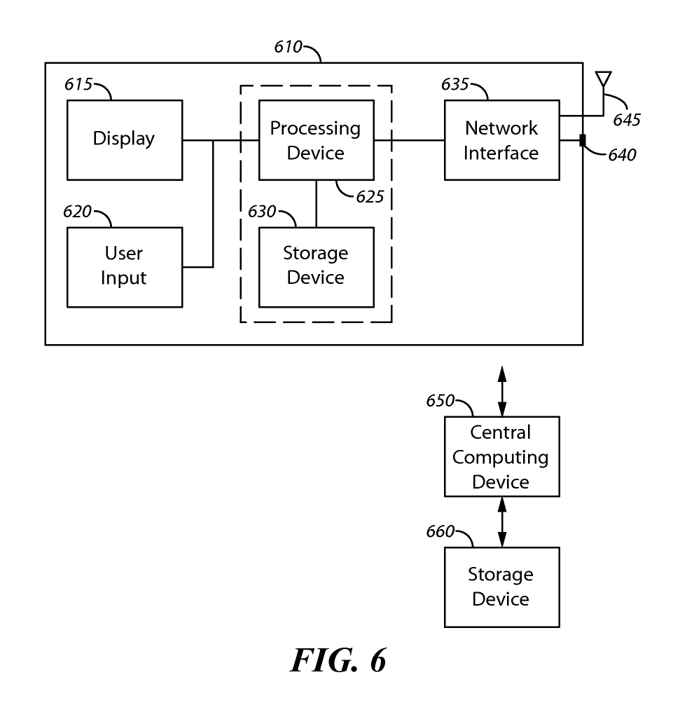

Those skilled in the art will appreciate that the above described processes are readily enabled using any of a wide variety of available and/or readily configured platforms including partially or wholly programmable platforms as are known in the art or dedicated purpose platforms as may be desired for some applications. Referring now to FIG. 6, an illustrative approach to such a platform will now be described. A user controlled electronic communication device 610 includes a display device 615 configured to provide to a user the information and tools used to create and receive electronic communications. The electronic communication device 610 also includes a user input device 620 configured to receive user input for defining electronic communications and otherwise controlling the electronic communication device 610. One skilled in the art can appreciate that the display device 615 and user input device 620 may comprise any of the number of display or input devices as known in the art.

The processing device 625 is configured to be in communication with the display device 615 and the user input device 620. The processing device 625 is in communication with a local storage device 630 such as a memory device. As known in the art, the processing device 625 and local storage device 630 may comprise separate hardware platforms or may be incorporated into a single hardware platform with various possible configurations. A network interface 635 is in communication with the processing device 625 and is configured to enable communications with other electronic communication devices either over a wired network port 640 or through a wireless connection 645. Those skilled in the art will recognize and appreciate that such a processing device 625 can comprise a fixed purpose hardwired platform or can comprise a partially or wholly programmable platform. All of these architectural options are well known and understood in the art and require no further description herein.

In an additional approach, the functionality or logic described herein may be embodied in the form of code that may be executed in a separate processor circuit. If embodied in software, each block or functionality may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s). Accordingly, the above functionality can be deployed via a tangible computer readable medium storing instructions readable by a computing device such as the processing device 625, wherein the instructions cause the computing device to effect operations such as the functionality or logic described herein. The storage device 630 is just one example of such a tangible computer readable medium as known in the art.

The electronic communication device 610 is further configured to communicate with a central computing device 650 either through a direct communication channel or through one or more networks such as a local area network or a wide area network such as the internet. The central computing device 650 is configured to communicate with a storage device 660 that in turn is configured to store content and icons associated with individual pieces of content that can be downloaded to individual electronic communication devices for enabling the inclusion of the content into electronic messages. The central computing device 650 may be a single computing device or server or may be one of multiple computing devices that together operate to provide the functionality of the central computing device 650 as described herein. Similarly, the storage device may be a single memory or a broad based multiple device memory as are known in the art. The storage device 660 can also comprise cloud storage or cloud computing resources as are also known in the art. Moreover, the central computing device 650 may also include a tangible computer readable medium that stores instructions that when executed by the central computing device 650 causes the central computing device to effect certain operations as described herein.

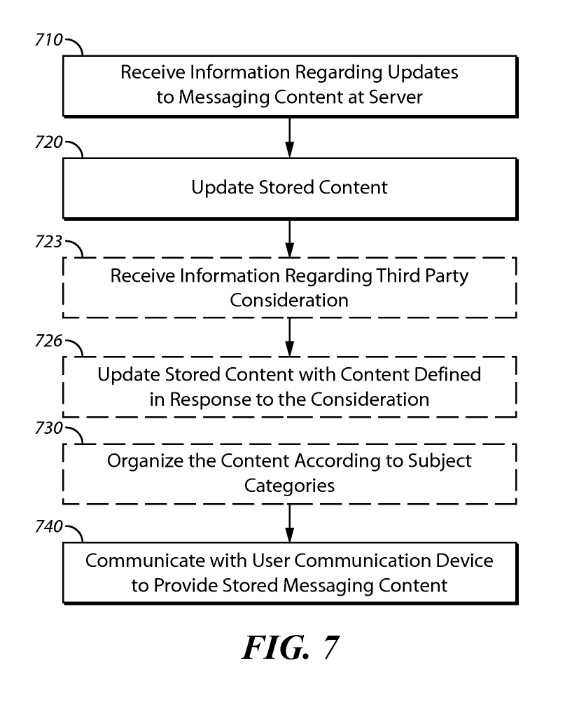

With respect to FIG. 7, one example method of operation of such a central computing device 650 will be described. The method includes at 710 receiving at a computing device 650 in communication with a storage device 660 information comprising updates of messaging content stored at the storage device 660. In this example, the content includes icons, audio clips, video clips, “canned” text sequences, and the like which are used in electronic communications between users. In response to receiving the information, the computing device 650 communicates with the storage device 660 to update at 720 the content stored at the storage device 660. Optionally, the method may include receiving 723 information regarding consideration paid by a third party and updating 726 the content stored at the storage device 660 with content defined at least in part in response to the consideration paid by the third party. For example, the controller of the central computing device 650 may receive a payment from a third party such that the central computing device 650 will provide content and icons for use by the electronic communication device as defined by the third party.

The method of FIG. 7 may also optionally include organizing 730 the content according to subject categories wherein the communication with the user communication device comprises providing icons associated with at least one of the subject categories to the user communication device. In this example approach, the content may be organized at the storage device 660 in particular categories, examples of which include commercially defined content, seasonal content, and individual topics of content, such as sports related content, pop culture related content, or the like. The method of FIG. 7 also includes the computing device 650 communicating 740 with the user communication device to provide at least one of the messaging content elements stored in the storage device 660 to the user communication device for use in the electronic messages sent from the user communication device.

So configured, the central computing device together with a storage device stores, organizes, maintains, and updates icons and associated content available for inclusion in electronic messages, such that the content and icons can be provided to user based electronic communication devices for inclusion into electronic communications such as instant messages and the like. The user experiences a richer communication experience through the ability to quickly toggle between categories of content to include in an electronic communication such as text, emoticon, audio, video and the like. Moreover, the user experience is further enhanced through periodic changing of the content available for inclusion in the electronic message. A communication service provider may also experience benefits in view of the various commercial relationships that can be cultivated in the context of providing and updating categories and individual pieces of content that can be provided to the various users of a particular communication service provider.

Those skilled in the art will recognize that a wide variety of modifications, alterations and combinations can be made with respect to the above described embodiments without departing from the scope of the invention. For example, these teachings may be applied to any number of electronic communication devices or any number of electronic communication settings. For example, these teachings may be applied for communication within a closed local network, a local wireless communication network, or over a wide area network such as typical internet-based communications. Such modifications, alterations and combinations are to be viewed as being within the ambient of the inventive concept.

What is claimed is:

1. A method comprising:
receiving a signal to prepare an electronic message to be sent from a communication device;
displaying a plurality of icons on a display device for the communication device, wherein a sub-set of the plurality of icons includes icons corresponding to different categories of content to include in the electronic message;
receiving from a central computing device predefined content available to be inserted into the electronic message;
receiving a user signal indicating selection of a selected icon of the sub-set of the plurality of icons;
in response to receiving the user signal indicating selection of the icon of the sub-set of the plurality of icons, displaying a second set of icons at least partially different from the first set of icons,
wherein individual ones of the second set of icons represent content corresponding to a category of content corresponding to the selected icon of the sub-set of the plurality of icons and available to be inserted into the electronic message in response to selection of the individual icon,
wherein at least some of the second set of icons represent the predefined content from the central computing device.

2. The method of claim 1 wherein the receiving the signal comprises receiving the signal from a user input device in communication with the communication device.

3. The method of claim 1 wherein the displaying the plurality of icons comprises displaying individual ones of the icons that correspond to content to be inserted into the electronic message.

4. The method of claim 1 further comprising periodically communicating with the central computing device to update the predefined content available to be inserted into the electronic message.

5. The method of claim 4 wherein the second set of icons automatically updates with a different set of icons to reflect the update of the predefined content available to be inserted into the electronic message.

6. The method of claim 4 further comprising defining in response user input how to periodically communicate with the central computing device to update the predefined content.

7. The method of claim 6 wherein the defining comprises defining at least one of: a timing of periodically communicating with the central computing device, categories of content to update, a method of periodically communicating with the central computing device, and types of content to receive from the central computing device.

8. The method of claim 7 wherein the defining the types of content to receive from the central computing device comprises authorizing receiving commercially defined content, seasonal content, and individual topics of content.

9. The method of claim 1 wherein the predefined content is defined at least in part in response to consideration paid by a third party.

10. A tangible computer readable medium storing instructions readable by a computing device, wherein the instructions cause the computing device to effect operations comprising:
receiving a signal to prepare an electronic message to be sent from a communication device;
displaying a plurality of icons on a display device for the communication device, wherein a sub-set of the plurality of icons includes icons corresponding to different categories of content to include in the electronic message;
receiving from a central computing device predefined content available to be inserted into the electronic message;
receiving a user signal indicating selection of a selected icon of the sub-set of the plurality of icons;
in response to receiving the user signal indicating selection of the icon of the sub-set of the plurality of icons, displaying a second set of icons at least partially different from the first set of icons,
wherein individual ones of the second set of icons represent content corresponding to a category of content corresponding to the selected icon of the sub-set of the plurality of icons and available to be inserted into the electronic message in response to selection of the individual icon,
wherein at least some of the second set of icons represent the predefined content from the central computing device.

11. The tangible computer readable medium of claim 10 wherein the receiving the signal comprises receiving the signal from a user input device in communication with the communication device.

12. The tangible computer readable medium of claim 10 wherein the displaying the plurality of icons comprises displaying individual ones of the icons that correspond to content to be inserted into the electronic message.

13. The tangible computer readable medium of claim 10 further comprising instructions to cause the computing device to perform operations comprising periodically communicating with the central computing device to update the predefined content available to be inserted into the electronic message.

14. The tangible computer readable medium of claim 13 further comprising instructions to cause the computing device to automatically update the second set of icons with a different set of icons to reflect the update of the predefined content available to be inserted into the electronic message.

15. The tangible computer readable medium of claim 13 further comprising instructions to cause the computing device to perform operations comprising defining in response user input how to periodically communicate with the central computing device to update the predefined content.

16. The tangible computer readable medium of claim 15 wherein the defining comprises defining at least one of: a timing of periodically communicating with the central computing device, categories of content to update, a method of periodically communicating with the central computing device, and types of content to receive from the central computing device.

17. A method comprising:
receiving at a computing device in communication with a storage device information comprising updates to content stored at the storage device, the content comprising messaging content elements for use in user created electronic messages;
in response to receiving the information, the computing device communicating with the storage device to update to the content stored at the storage device;
the computing device communicating with a user communication device to provide at least one of the messaging content elements stored in the storage device to the user communication device for use in user created electronic messages sent from the user communication device.

18. The method of claim 17 further comprising organizing the content according to subject categories and wherein the communication with the user communication device comprises providing messaging content elements associated with at least one of the subject categories to the user communication device.

19. The method of claim 18 wherein organizing the content according to subject categories comprises commercially defined content, seasonal content, and individual topics of content.

20. The method of claim 17 further comprising receiving information regarding consideration paid by a third party and updating the content stored at the storage device with content defined at least in part in response to the consideration paid by a third party.
